(19) United States
(12) Patent Application Publication
(10) Pub. No.: US 2004/0205033 A1
(43) Pub. Date: Oct. 14, 2004

(54) Print-to-mail system and method

(76) Inventor: Shell Sterling Simpson, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/999,037

(22) Filed: Nov. 15, 2001

(51) Int. Cl. G06F 17/60; G07B 17/02; G06F 17/24

(52) U.S. Cl. 705/408; 705/24; 715/500

(57) ABSTRACT

The present disclosure relates to a print-to-mail system and method. In one arrangement, the system and method pertain to obtaining data to be printed, facilitating arrangement of the data in a print-to-mail format, and printing documents in a print-to-mail format using the arrangement. In addition, the present disclosure relates to a print-to-mail device. In one arrangement, the print-to-mail device comprises hard copy generation hardware, a processing device, and memory including an embedded network server, the server hosting a print-to-mail service with which the arrangement of data to be printed can be selected by a user.

### FIELD OF THE INVENTION

The present disclosure relates to a system and method that facilitates print-to-mail functionality. More particularly, the disclosure relates to a web-based system and method with which data can be identified and/or arranged for printing as a mailing.

### BACKGROUND OF THE INVENTION

Small to medium sized business offices often generate and send their own bills to their clients. Traditionally, this task entailed printing out bills, manually inserting the bills into envelopes, providing the appropriate postage on the envelopes, and depositing the envelopes with a mail carrier.

Recently, devices have been developed that simplify the above-described process. One such device is the print-to-mail appliance which is adapted to print on relatively heavy weight media, fold the media (e.g., along fold lines provided on the media), and seal the bills (e.g., by heating heat-activated adhesive provided on the media) to form a mailing. In another example, a print-to-mail accessory can be added to a conventional printing device (e.g., printer) to obtain the same functionality.

Although the print-to-mail devices work well for their designated purposes, formatting the data to be provided on the print-to-mail media can be problematic. In particular, the software typically used to enter and/or maintain the data to be printed does not support print-to-mail formatting. Accordingly, the user must find some way in which to format the raw data so it can be appropriately mapped to the print-to-mail media. This task can be tedious and, indeed, nearly impossible for users who are not computer savvy.

Due to the difficulties described above, solutions have been provided that are designed to aid the user in formatting data for print-to-mail printing. One such solution comprises a software application with which the user can create software “recipes” that can be implemented using specialized printing device drivers developed for that purpose and, if written correctly, provide the desired formatting. Although this solution is viable, it requires the user to create tedious specifications (which can be thought as a sort of program) that arrange the data for printing. Again, this can create problems for those that are not familiar and/or comfortable with computer programming.

In view of the aforementioned difficulties, it can be appreciated that it would be desirable to have a print-to-mail system that avoids one or more of the problems presently encountered with formatting data for print-to-mail printing.

### SUMMARY OF THE INVENTION

The present disclosure relates to a print-to-mail system and method. In one variation, the system and method pertain to obtaining data to be printed, facilitating arrangement of the data in a print-to-mail format, and printing documents in a print-to-mail format using the arrangement.

In addition, the present disclosure relates to a print-to-mail device. In one variation, the print-to-mail device comprises hard copy generation hardware, a processing device, and memory including an embedded network server, the server hosting a print-to-mail service with which the arrangement of data to be printed can be selected by a user.

Other systems, methods, features, and advantages of the invention will become apparent upon reading the following specification, when taken in conjunction with the accompanying drawings.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a schematic representation of the general operation of the invention.

FIG. 2 is an example system in which the invention can be implemented.

FIG. 3 is a schematic of a print-to-mail device shown in FIG. 2.

FIG. 4 is a flow diagram that provides an overview of the manner in which the system shown in FIG. 2 can be used to produce print-to-mail format documents.

FIGS. 5A and 5B provide a flow diagram of operation of a print-to-mail service in providing print-to-mail functionality.

FIGS. 6A and 6B provide example web pages that can be used in the method of FIGS. 5A and 5B.

### DETAILED DESCRIPTION

Disclosed is a system and method for facilitating print-to-mail format printing. Generally speaking, the system and method can be used to access a network-based (e.g., web-based) imaging service that enables the user to arrange the imaging data for print-to-mail format printing. Once the arrangement has been selected, it can be stored and, if desired, one or more hard copy documents (i.e., mailings) can be generated.

To facilitate description of the inventive system and method, example systems are discussed with reference to the figures. Although these systems are described in detail, it will be appreciated that they are provided for purposes of illustration only and that various modifications are feasible without departing from the inventive concept. After the description of the example systems, examples of operation of the systems are provided to explain the manners in which print-to-mail functionality can be obtained.

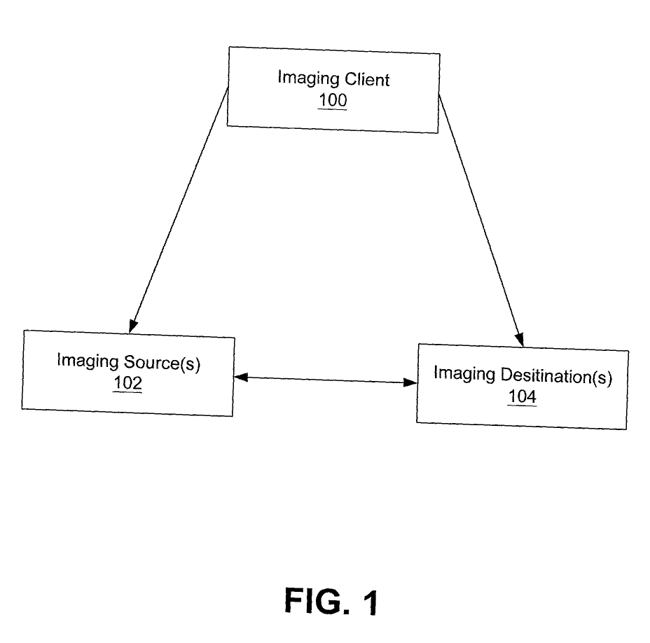

FIG. 1 is a schematic representation of the general operation of the invention. As shown in this figure, an imaging client 100 communicates with one or more imaging sources 102 and one or more imaging destinations 104. The imaging source(s) 102 represent any of a wide variety of devices/services that can be accessed by the imaging client 100 and used to input data that will be used to create a document, such as a mailing. Once the imaging data have been input, the imaging client 100 can identify data from the imaging source(s) 102 that are to be retrieved by the imaging destination(s) 104 for printing, as well as the arrangement of the data within the printed document. The image destination(s) 104 can then print the document(s) according to the client's selection. As will be apparent from the discussions that follow, the above-described manner of operation greatly increases the ease with which mailings can be generated using a print-to-mail device.

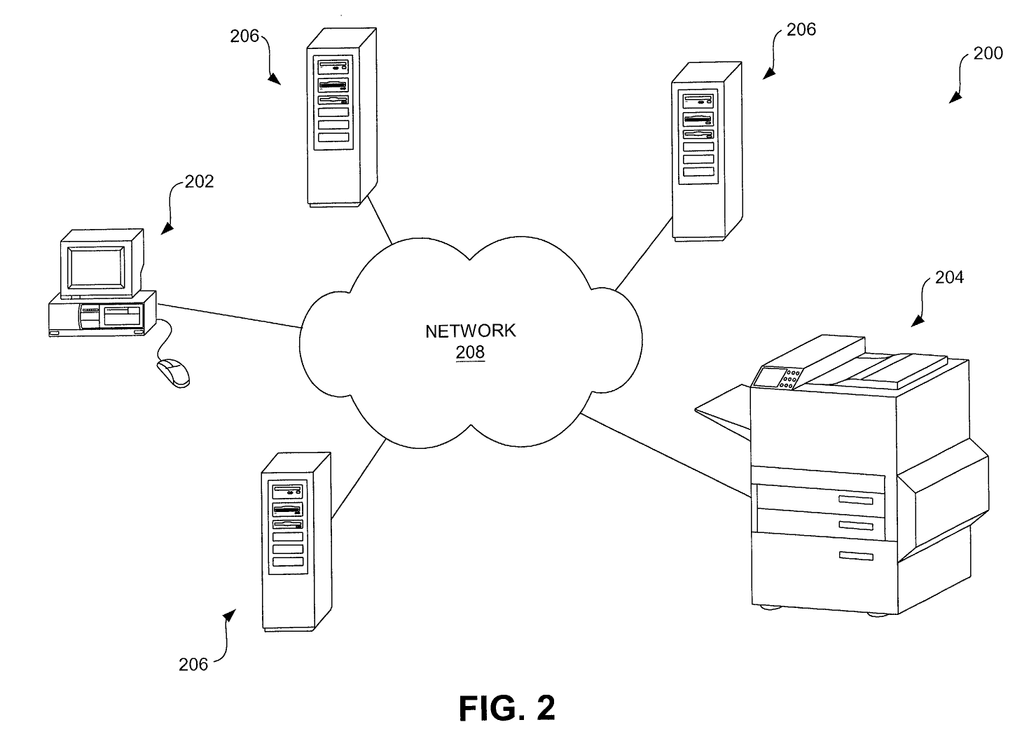

FIG. 2 illustrates an example system 200 with which the invention can be implemented. As indicated in this figure, the example system 200 generally comprises a computing device 202, a print-to-mail device 204, and one or more network servers 206, each of which can be connected to a network 208. As indicated in FIG. 2, the computing device 202 can be arranged as a personal computer (PC). More broadly, however, the computing device 202 can comprise substantially any device that can be used to communicate via the network 208 and, therefore, access and/or be accessed by print-to-mail services made available over the network. By way of example, the computing device 202 can alternatively comprise a notebook computer, Macintosh computer, handheld computer such as a personal digital assistant or mobile telephone, smart card, etc.

The print-to-mail device 204 comprises any device that is capable of print-to-mail functionality, i.e., that is capable of printing documents in a format designed to be folded and mailed without the need for an envelope. Although the term “print-to-mail device” is used herein, it is to be understood that the disclosure is not limited to any particular type of device that provides this functionality. Accordingly, the term is intended to include any appliance or printing device (e.g., printer, photocopier, facsimile machine, multifunction peripheral (MFP), etc.) that either inherently provides this functionality or which provides it when a suitable print-to-mail accessory is used in conjunction therewith. An example of a suitable print-to-mail device is a print-to-mail appliance available under the name Print To Mail™ Accessory from the Hewlett-Packard Company.

The one or more network servers 206 typically comprise computing devices similar in configuration to the computing device 202, but which normally possess greater resources in terms of processing power, memory, and/or storage space. As will be apparent from the discussions provided below, the network servers 206 are typically used with the Internet and, therefore, typically comprise web servers. The network 208 normally comprises one or more sub-networks that are communicatively coupled to each other. By way of example, these networks can include one or more local area networks (LANs) and/or wide area networks (WANs) that comprise a set of networks that forms part of the Internet. In addition to the network connections shown in FIG. 2, one or more of the computing device 202 and servers 206 can be directly connected to the print-to-mail device 204 (not shown). Direct connection between the computing device 202 and the print-to-mail device 204 may be likely where the print-to-mail device is used in a home or small office environment in which the user does not have access to a network. Direct connection between a network server 206 and the print-to-mail device 204 may be likely where the server functions as a print server controlled by a print-to-mail service.

As noted above, other system arrangements are possible for implementation of the invention. For instance, the system can be arranged as one or more of the example systems identified in U.S. patent application Ser. No. ______, entitled “System and Method for Producing Business Cards,” by Shell Simpson, Ward Foster, and Kris Livingston and bearing Attorney Docket No. 10008203-1, the disclosure of which is hereby incorporated by reference into the present disclosure. In such a case, the data to be printed (i.e., imaging data) can be accessed by imaging destinations (e.g., print-to-mail services) in an, at least partially, automated manner.

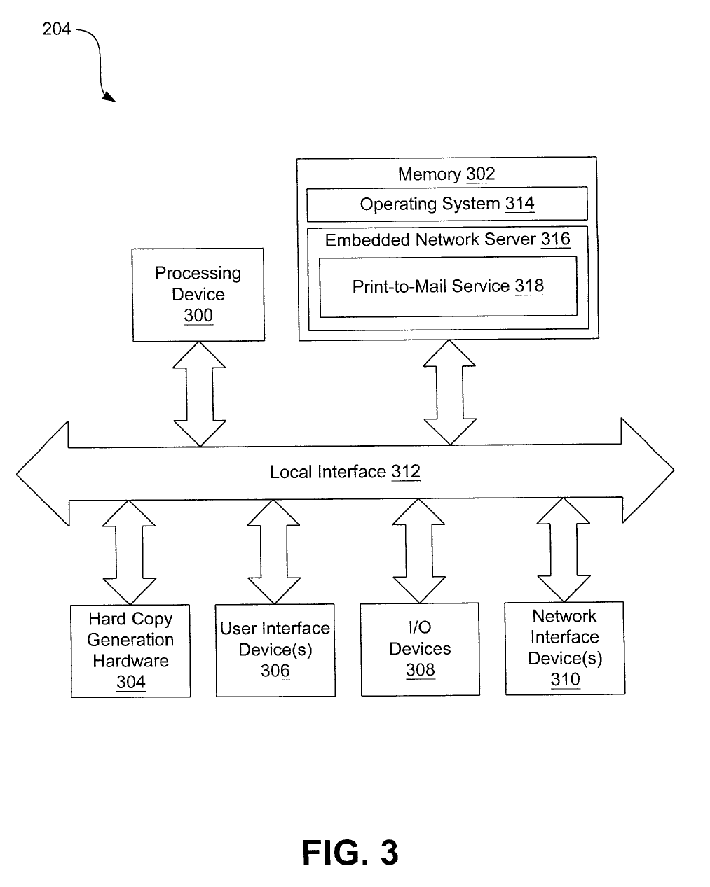

FIG. 3 is a schematic view illustrating an example architecture for the print-to-mail device 204 identified in FIG. 2. As indicated in FIG. 3, the print-to-mail device 204 can generally comprise a processing device 300, memory 302, hard copy generation hardware 304, one or more user interface devices 306, one or more input/output (P/O) devices 308, and one or more network interface devices 310, each of which is connected to a local interface 312 that normally comprises one or more internal and/or external buses.

The processing device 300 is adapted to execute commands stored in memory 302 and can comprise a general-purpose processor, a microprocessor, one or more application-specific integrated circuits (ASICs), a plurality of suitably configured digital logic gates, and other well known electrical configurations comprised of discrete elements both individually and in various combinations to coordinate the overall operation of the print-to-mail device 204. The memory 302 can include any one of a combination of volatile memory elements (e.g., random access memory (RAM, such as DRAM, SRAM, etc.)) and nonvolatile memory elements (e.g., ROM, hard drive, tape, CDROM, etc.).

The hard copy generation hardware 304 comprises the components with which the print-to-mail device 204 can generate hard copy documents and, more particularly, with which the device can generate printed mailings. For example, the hard copy generation hardware 304 can comprise a print engine that is possible of many different configurations as well as a folding and sealing mechanism that is used to fold the mailing and seal it along one or more of its edges.

The one or more user interface devices 306, where provided, comprise those components with which the user can interact with the print-to-mail device 204. By way of example, the user interface devices 306 comprise one or more function keys and/or buttons with which the operation of the device 204 can be controlled, and a display, such as a liquid crystal display (LCD), with which information can be visually communicated to the user and, where the display comprises a touch-sensitive screen, commands can be entered.

With further reference to FIG. 3, the one or more I/O devices 308 are adapted to facilitate communications of the print-to-mail device 204 with another device and may therefore include one or more serial, parallel, small computer system interface (SCSI), universal serial bus (USB), IEEE 1394 (e.g., Firewire™), and/or personal area network (PAN) components. The network interface devices 310 comprise the various components used to transmit and/or receive data over a network 208. By way of example, the network interface devices 310 include a device that can communicate both inputs and outputs, for instance, a modulator/demodulator (e.g., modem), wireless (e.g., radio frequency (RF)) transceiver, a telephonic interface, a bridge, a router, network card, etc.

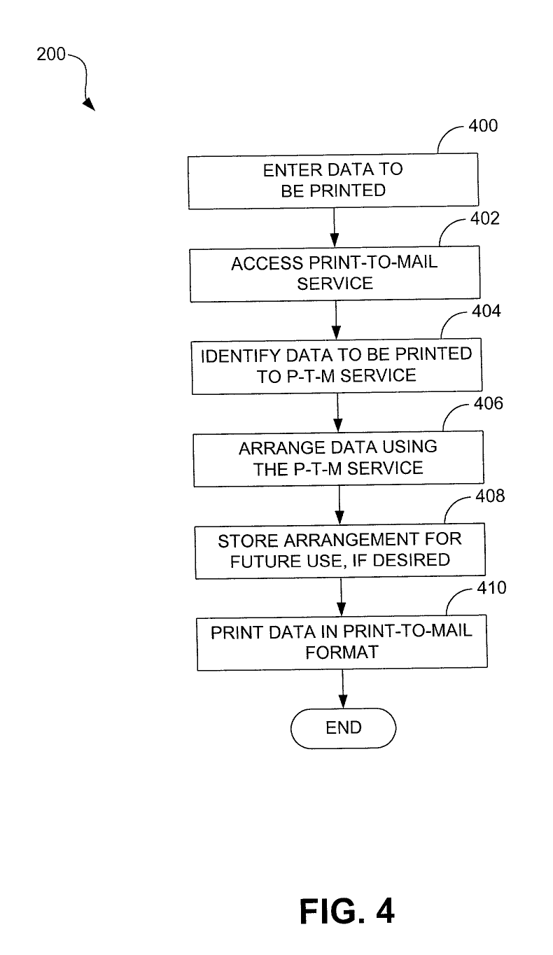

The memory 302 typically comprises an operating system 314. In addition, where the print-to-mail device 204 is adapted to support a service that facilitates print- to-mail formatting, the memory 302 typically includes an embedded network server 316. The operating system 314 controls the execution of other software and/or firmware and provides scheduling, input-output control, file and data management, memory management, and communication control and related services. The embedded network server 316 comprises software and/or firmware that is used to serve information to the network 208. Where the network comprises the Internet (public or private), the embedded network server 316 may function as an embedded web server. As indicated in FIG. 3, the embedded network server 316, where provided, comprises a print-to-mail service 318 that, as is discussed in greater detail below, can be used as an imaging destination that facilitates the print-to-mail printing process. The operation of the network server 316 and the print-to-mail service 318 when acting in this capacity is described below with reference to FIGS. 4-6B. Although the print-to-mail service 318 has been identified as being supported by the print-to-mail device 204, persons having ordinary skill in the art will appreciate that this service could, alternatively, be provided by another device, for instance one or more of the network servers 206. As will be apparent from the discussions that follow, however, the location of the print-to-mail service 318 is unimportant to the operation of the inventive system and method.

Various software and/or firmware has been described herein. It is to be understood that this software and/or firmware can be stored on any computer-readable medium for use by or in connection with any computer-related system or method. In the context of this document, a computer-readable medium denotes an electronic, magnetic, optical, or other physical device or means that can contain or store a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

An example system having been described above, operation of the system will now be discussed. In the discussions that follow, flow diagrams are provided. It is to be understood that any process steps or blocks in these flow diagrams represent modules, segments, or portions of code that include one or more executable instructions for implementing specific logical functions or steps in the process. It will be appreciated that, although particular example process steps are described, alternative implementations are feasible. Moreover, steps may be executed out of order from that shown or discussed, including substantially concurrently or in reverse order, depending on the functionality involved.

FIG. 4 provides an overview of the manner in which a user can use the example system 200, or another appropriate system, to facilitate print-to-mail printing. Beginning with block 400, the data are entered that may or may not ultimately be used to print in print-to-mail format. These data can be entered by the user, or can have been entered by another. The data can comprise substantially any data that the user may wish to print (i.e. imaging data) as a mailing. By way of example, the data can comprise billing data that will be distributed to customers/clients of a business. In any case, the data can be entered into an appropriate imaging source such as an accounting application (e.g., Peachtree™, Quicken™, etc.) or an appropriate database management system (e.g., Oracle™, Sysbase™, etc.). As will be apparent from the discussions that follow, the imaging source, in addition to being used to enter the data, can be used as a data source that, in some cases, can be accessed by the print-to-mail service 318 (imaging destination).

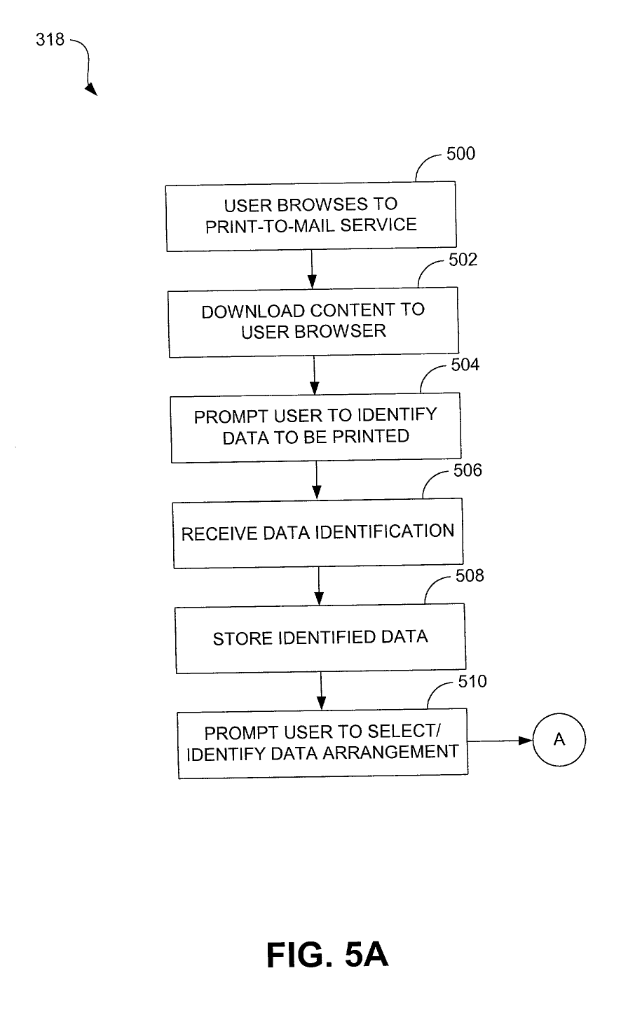

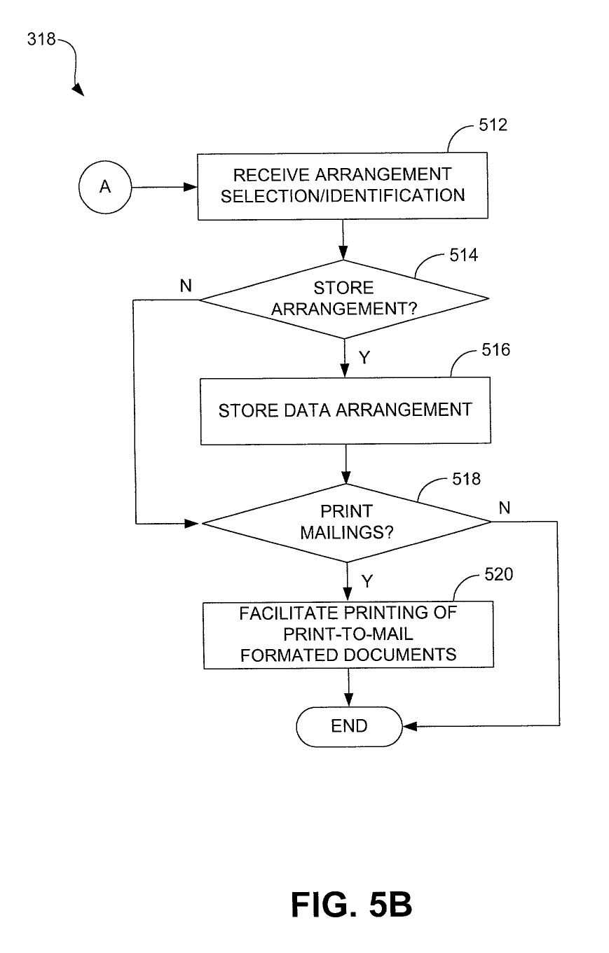

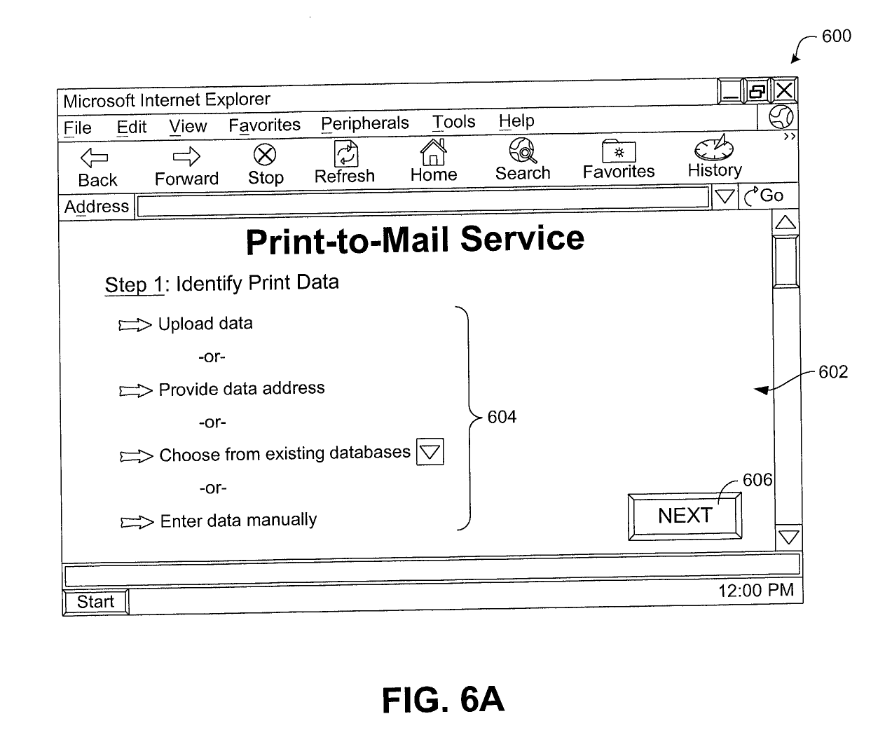

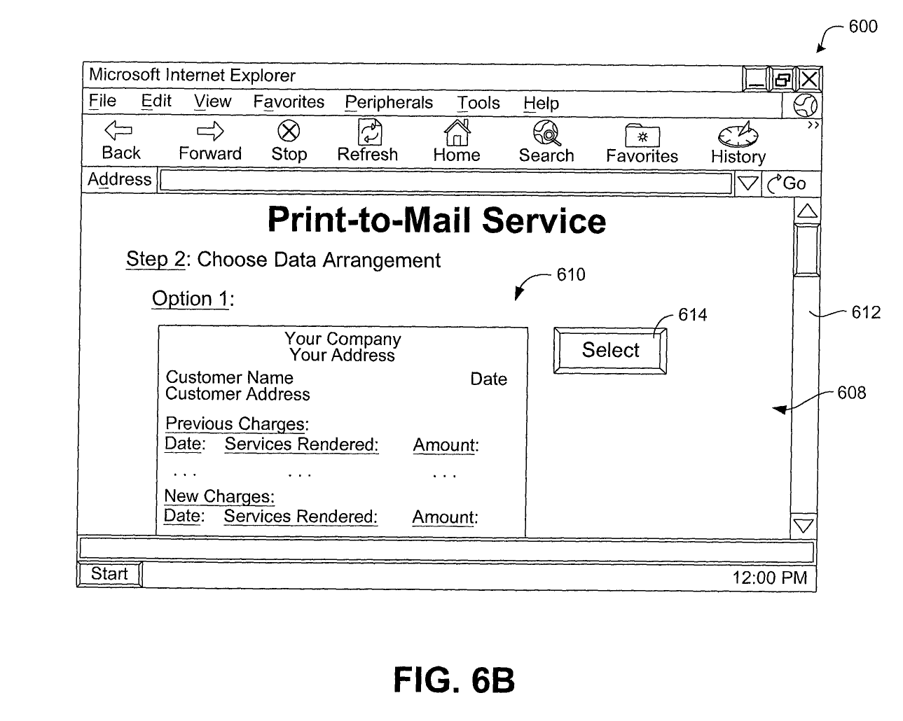

Once the data have been entered, the user can access the print-to-mail service 318, as indicated in block 402. Typically, this access is gained via the network 208. For instance, where the print-to-mail service 318 executes on the print-to-mail device 204, the user can access the service by directing an appropriate browser to the address (e.g., uniform resource locator (URL)) of the service. After the print-to-mail service 318 has been accessed, the user can identify the data that are to be printed in the print-to-mail format to the service, as indicated in block 404. As is discussed below in relation to FIGS. 5A and 6A, this identification can be made in several different forms. Irrespective of the manner in which the identification is made, however, the identification will be used by the print-to-mail service 318 to access the data, or at least identify where the data can be located by the service 318.

Once the print-to-mail service 318 is in possession of the data to be printed, the user can arrange the data using the service, as indicated in block 406. Generally speaking, the user can control where the data will be provided on the printed document (e.g., mailing), fonts used to represent the data, the spacing between entries, and any other arrangement details. After the user is satisfied with the arrangement, the user can, optionally, store the arrangement for future use, as indicated in block 408. At this point, the user can print the data in a print-to-mail format, as indicated in block 410, by issuing a print command to the print-to-mail service 318.

Referring now to FIGS. 5A-5B and 6A-6B, a more detailed example of the operation of the system 200 will be provided. Beginning with block 500 of FIG. 5A, the user browses to the print-to-mail service 318 using an appropriate network browser (e.g., web browser) that executes on the user computing device 202. Typically, this service 318 comprises a web site that is accessed via the Internet (including the Intranet). As noted above, the print-to-mail service 318 can, for example, be executed upon the print-to-mail device 204. Once the print-to-mail service 318 is accessed, the service downloads content to the user browser, as indicated in block 502. This content normally includes various text and/or graphics that are displayed to the user to facilitate interfacing between the user and the service 318. As described below, this content can, optionally, include one or more applications (e.g., applets) that perform certain functions to aid the print-to-mail service 318 and, thereby, facilitate the print-to-mail printing process.

After the print-to-mail service 318 has been accessed and the user communicates an interest in obtaining print-to-mail functionality, the service 318 prompts the user to identify the data to be printed, as indicated in block 504. Typically, this prompting is effected with an interface (e.g., graphical user interface (GUI)) in the form of one or more web pages that are presented to the user with the user browser. FIG. 6A is a schematic representation of an example browser interface 600 in which an example web page 602 is shown that can be used to prompt the user for this information. Although the browser interface 600 is shown as a Windows-based browser interface, it will be appreciated that substantially any browser interface could be used. Therefore, the interface may not appear as indicated in FIG. 6A, particularly where the user computing device 202 comprises a handheld computing device such as a PDA or mobile telephone.

As indicated in FIG. 6A, the page 602 can identify various different options 604 with which the data identification can be made. By way of example, these options can include one or more of an upload option, address identification option, a database selection option, and a manual entry option. With the upload option, the user can identify one or more databases from which the data is to be retrieved. These databases can, for instance, reside on the user computing device 202 (e.g., on a hard disk) and may comprise one or more files associated with a given user application (e.g., Peachtree™, Quicken™, etc.). If this option is selected, one or more applications (e.g., applets) that were downloaded to the user browser as content can form part of an upload mechanism that is used to perform the upload operation. For instance, the applications can generate a pop-up dialogue box or further web page (neither shown) with which the user can provide one or more file names from which the data is to be retrieved. Where the user does not know of the correct filename(s), the applications can, for instance, be used to scan the user's computing device hard disk so that the user may browse through the contents of the hard disk to locate the appropriate file(s).

With the address identification option, the user can be prompted to identify the address (e.g., URL) of the database(s) to be accessed. Again, prompting can be effected through use of a dialogue box or further web page (neither shown). Where the database selection option is chosen, the user can be presented with a drop-down menu (not shown) with which the user can select from one or more databases of which the print-to-mail service 318 is aware. For instance, the list can include the name of one or more popular database management systems (e.g., Oracle, Cybase, etc.) that the user may presently use to store the data to be printed. In such a circumstance, the user may further be prompted to provide additional information that identifies the user's data. For example, the user may be prompted to provide a structured query language (SQL) query to identify which data (e.g., records) are to be accessed by the print-to-mail service 318, and any other details that may be pertinent to identifying and accessing the data (e.g., the credentials needed to access the database, the network address of the database, the name of the database, etc.). Finally, if the manual entry option is selected, the user can be permitted to manually enter the data to be printed. Once more, this can be accomplished by providing the user with a dialogue box or further web page (neither shown). After the identification information has been provided, the user can continue the process by, for instance, selecting a “next” button 606.

With reference back to FIG. 5A, the data identification can be received by the print-to-mail service 318, as indicated in block 506. Alternatively, a reference or other information required to access the data as needed could be received. At this point, the various data to be printed (or reference or other information required to access the data) can be stored by the service 318, as indicated in block 508. Where the service 318 is supported by the print-to-mail device 204, (i.e., embedded within the device), the data can be stored within memory 302 (e.g., an internal hard disk) of the device. Where the service 318 is not supported by the print-to-mail device 204, or where the device lacks the storage resources to store the data in memory 302, the data can be stored in another appropriate storage location that is accessible by the service.

Next, the user can be prompted to select or identify the arrangement (i.e., composition) that the data will have on the print media (e.g., paper). Specifically, the user can identify the placement of each piece of information that, for instance, was retrieved from the imaging source. Again, this selection or identification typically is facilitated with a user interface that comprises one or more web pages. An example web page 608 adapted for this purpose is illustrated in FIG. 6B. As indicated in this figure, the web page 608 can, optionally, comprise one or more default arrangements for the user's selection. By way of example, each arrangement can be visually represented as a mock print-to-mail format document (i.e., mailing) 610. The various different arrangement options can be viewed by the user by, for instance, scrolling through the options using a scroll bar 612 of the browser interface 600. As depicted in FIG. 6B, the various mock documents provide a what-you-see-is-what-you-get (WYSIWYG) view of the document so that the user can visualize what the finished mailing will look like. The visualization can include actual data selected previously.

Although, as described above, the user can select from various predetermined options provided by the print-to-mail service 318, the user can, optionally, manually arrange the various pieces of information in a mock document to personalize the appearance to suit the user's needs. This can be achieved with a further web page (not shown) which can be accessed with the user's browser. In another alternative, the user can designate a default arrangement (i.e., composition) stored in an appropriate storage location (e.g., archive) with yet another web page (not shown). In any case, the selection can be communicated to the print-to-mail service 318 in some manner, for instance by selection of a “select” button 614. Typically, the selections comprise placement of static information for each mailing (such as account identification information) along with one or more sets of records pertaining to the account describing particular account activity, such as purchases and payments. This information, having been previously selected, can be placed in specific regions of the mailer (possibly both front and back) to achieve the desired layout.

Returning to FIG. 5A, once the arrangement for the print-to-mail format document has been communicated, flow continues on to FIG. 5B and block 512 at which the arrangement is received by the print-to-mail service 318. At this point, it can be determined whether the user wishes to store the arrangement for future use or reference, as indicated in decision element 514. If not, flow continues to decision element 518 described below. If, on the other hand, the user would like to store the arrangement, flow continues on to block 516 at which the arrangement is stored by the print-to-mail service 318. Again, storage can be to the memory 302 of the print-to-mail device 204, or to any other storage location that is accessible by the service 318.

Irrespective of whether the arrangement is stored by the service 318, it can be determined whether print-to-mail format documents (i.e., mailings) are to be printed, as indicated in decision element 518. If such documents are not to be printed, flow for the session is terminated and the user may return to the service 318 at a later time to print the documents, if desired. If, however, the user does wish for documents to be printed, the print-to-mail service 318 facilitates this printing, as indicated in block 520, by, for example, sending a print job comprising the data and its arrangement to the hard copy generation hardware 304.

Operating in the manner described above, the system and method can be used to simplify the print-to-mail process. In particular, the system and method provide convenient means for identifying and arranging data that are to be printed in a print-to-mail format document such that no special programming is needed. Furthermore, because the print-to-mail layout is performed using a service that has knowledge of the specific characteristics of the print-to-mail device 204, the layout process is much less error prone. Additionally, because this process is performed using the web service, no special software installation or configuration is required.

While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A method for print-to-mail printing, comprising the steps of:
obtaining data to be printed;
facilitating arrangement of the data in a print-to-mail format; and
printing documents in a print-to-mail format using the arrangement.

2. The method of claim 1, wherein the step of obtaining data comprises receiving data uploaded from a user via a network.

3. The method of claim 1, wherein the step of obtaining data comprises retrieving data from a location identified by a user via the network.

4. The method of claim 1, wherein the step of obtaining data comprises receiving data manually entered by a user via a network.

5. The method of claim 1, wherein the step of facilitating arrangement of the data comprises presenting a web site comprising one or more web pages to a user.

6. The method of claim 5, wherein the web site comprises a user interface with which the user can communicate arrangement selections.

7. The method of claim 6, wherein the user interface includes a visual representation of a print-to-mail format document that will be printed.

8. The method of claim 5, wherein the web site is hosted on a print-to-mail device.

9. A system for print-to-mail printing, comprising:
means for obtaining data to be printed;
means for facilitating arrangement of the data in a print-to-mail format; and
means for printing documents in a print-to-mail format using the arrangement.

10. The system of claim 9, wherein the means for facilitating arrangement of the data comprises means for generating a web site.

11. The system of claim 10, wherein the web site comprises a user interface with which a user can communicate arrangement selections and view a representation of a print-to-mail format document that can be printed.

12. A print-to-mail device, comprising:
hard copy generation hardware;
a processing device; and
memory including an embedded network server, the server hosting a print-to-mail service with which the arrangement of data to be printed can be selected by a user.

13. The device of claim 12, wherein the hard copy generation hardware comprises a print engine.

14. The device of claim 12, wherein the hard copy generation hardware includes a folding mechanism.

15. The device of claim 12, wherein the hard copy generation hardware includes a sealing mechanism.

16. The device of claim 12, wherein the print-to-mail service includes logic configured to present a print-to-mail web site to a user.

17. The device of claim 16, wherein the web site comprises a user interface with which the user can communicate arrangement selections.
